(19) United States
(12) Patent Application Publication
(10) Pub. No.: US 2026/0150852 A1
(43) Pub. Date: Jun. 4, 2026

(54) TUNNEL FREEZER AND METHOD FOR FREEZING A LAYER OF FOODSTUFFS

(71) Applicant: Lamb Weston B.V., Breda (NL)

(72) Inventors: Petrus Johannes Cornelis Hogerheijde, Bergen op Zoom (NL); Bjørn Martijn Van den Oudenhoven, Lepelstraat (NL); Mark Ferdinand Van de Merwe, Goes (NL)

(21) Appl. No.: 19/122,201

(22) PCT Filed: Oct. 17, 2023
(86) PCT No.: PCT/NL2023/050542

§ 371 Date: Apr. 17, 2025

(30) Foreign Application Priority Data
Oct. 17, 2022 (NL) 2033335

(51) Int. Cl. A23B 2/80; F25D 13/06; F25D 17/06; F25D 23/06

(52) U.S. Cl. CPC A23B 2/803; F25D 13/067; F25D 17/06; F25D 23/065; F25D 23/069; F25D 2400/30

(57) ABSTRACT

A tunnel freezer is configured to freeze foodstuffs arranged in a layer. The tunnel freezer includes a housing, including a plurality of housing sections, and a conveyor unit configured to convey the layer of foodstuffs through each of the housing sections. Each housing section includes a ventilator, for providing a stream of a gaseous medium, and a cooling unit, arranged to cool the gaseous medium in the stream. A first of the housing sections is configured to force the stream of gaseous medium to flow through the layer of foodstuffs in a first direction. A second of the housing sections is configured to force the stream of gaseous medium to flow through the layer of foodstuffs in a second direction differing from the first direction. Also disclosed are a method for freezing foodstuffs that are arranged in a layer and a method for operating a tunnel freezer.

### CROSS-REFERENCE TO RELATED APPLICATIONS

This application is a national phase entry under 35 U.S.C. § 371 of International Patent Application PCT/NL 2023/050542, filed Oct. 17, 2023, designating the United States of America and published as International Patent Publication WO 2024/085751 A1 on Apr. 25, 2024, which claims the benefit, under Article 8 of the Patent Cooperation Treaty, of Dutch Patent Application Serial No. 2033335, filed Oct. 17, 2022.

### TECHNICAL FIELD

The present disclosure relates to a tunnel freezer configured to freeze foodstuffs that are arranged in a layer, and a method for operating the same. The present disclosure further relates to a method for freezing foodstuffs arranged in a layer.

### BACKGROUND

Known from the art are tunnel freezers that include a housing comprising a plurality of housing sections, and a conveyor unit configured to convey a layer of foodstuffs through each of the plurality of housing sections. Each housing section comprises a ventilator for providing a stream of gaseous medium, and a cooling unit arranged to cool the gaseous medium in the stream.

Typical examples of foodstuffs that are frozen using such tunnel freezers are fries, vegetables, fruits, (diced) meats or (shell-)fish. However, tunnel freezers can be used to freeze any foodstuffs that can be spread out over the conveyor unit to form a layer. For convenience, the present disclosure will explain embodiments of the disclosure in relation to fries, but this is just an example and not intended to limit the disclosure in any way.

For a fry to be considered frozen, all or at least most of the water present in the fry needs to have changed state from liquid water into solid ice. Water freezes at varying temperatures, depending on the medium in which the water is included. The applicant finds that, for fries (or, more specifically, the water in fries), the freezing point is about −14 degrees Celsius. When a fry freezes over, and the earlier mentioned phase change (from liquid water to solid ice) occurs, latent heat (also called latent energy) is released thereby increasing the temperature of the fry. The applicant finds that the latent heat released by a freezing fry can cause a jump in the temperature of the fry of around 5 degrees Celsius. If a fry freezes over at −14 degrees, that means that the resulting frozen fry will have a temperature of around −9 degrees Celsius. The frozen fry can then be cooled further, down to a final desired temperature, such as about −10, or about −12 degrees Celsius.

The skilled person will appreciate, however, that at the aforementioned freezing point water does not necessarily always and immediately freeze. In absence of ice nuclei (also called seed crystals) liquid water can be supercooled, reaching temperatures below the freezing point without having made the phase transition. The applicant finds that fries (or, more specifically, the water in fries) can be supercooled down to about −14 degrees Celsius. After a fry enters this supercooled state, the fry can still, at any point in time, freeze and release the latent heat as described before.

Measurement results that confirm this process are shown in the graph of FIG. 5. The graph shows a part of the change in temperature of individual fries S2 to S4 while they pass through a tunnel freezer. The X-axis indicates time. Since the individual fries S2 to S4 are conveyed through the tunnel freezer at a relatively constant speed, the passage of time shown on the X-axis can be directly related to the distance that fries S2 to S4 travel through the tunnel freezer. The Y-axis indicates temperature in degrees Celsius. For each fry S2 to S4, a sudden increase, or jump, in temperature is measured. This increase in temperature corresponds to the release of latent heat and can thus be assumed to indicate that the desired phase change has happened.

In tunnel freezers known from the art, the situation arises in which a batch of fries is measured as having a desired average temperature, such as between −10 to −12 degrees Celsius, preferably about −11 degrees Celsius, while a substantial portion of the fries in the batch is not actually frozen but is in this supercooled state. Some of the fries in this batch are thus incorrectly assumed to be frozen as the batch of fries is stored.

These fries, being in a supercooled state, however, will eventually still freeze. When this happens, the aforementioned latent heat is released and the average temperature of the stored batch of fries increases. The applicant finds that this effect is so substantial that it contributes to an increase in the final average temperature of a batch of fries in storage of up to 5 degrees Celsius. Batches of fries in storage that were frozen by tunnel freezers known from the art can have final average temperatures in a range of about −20 to about −15 degrees Celsius. This delayed release of latent heat and the resulting increase in temperature is considered very problematic.

For fries, as for all foodstuffs, there is a threshold temperature below which the fries may be stored to ensure quality of the fries and/or to avoid the fries being spoiled. If fries would be cooled down to just around this threshold temperature, the aforementioned delayed release of latent heat may result in a ‘final’ temperature of a batch of fries being higher than the threshold, putting the batch at risk of being spoiled.

Another problem that occurs, when fries are stored at an insufficiently low temperature, is that ice crystals will start to grow on the fries. These ice crystals may give a white glow to the fries, which is an undesirable aesthetic. The ice crystals may also cause the fries to freeze together, creating lumps of fries in the stored batch.

The expected temperature increase due to delayed release of latent heat may be anticipated by cooling the fries down to a temperature around the threshold temperature minus the expected temperature increase. This, however, is also not ideal since it requires additional cooling capacity from the tunnel freezer and also from storage facilities. Those, in turn, require additional investments and generally use more power. The skilled person will be aware of this incentive to cool and store fries to the highest possible temperature.

The skilled person will appreciate that the temperatures and temperature ranges mentioned in the introduction regarding fries may be different for other foodstuffs.

### BRIEF SUMMARY

The present disclosure provides for a tunnel freezer configured to freeze foodstuffs that are arranged in a layer, a method for operating the same, and a method for freezing a layer of foodstuffs in which at least some of the abovementioned shortcomings are at least partially alleviated.

The present disclosure further provides for a tunnel freezer, a method for operating the same, and a method for freezing foodstuffs capable of freezing foodstuffs such that a smaller part thereof is in a supercooled state and/or in a larger part thereof the phase change from liquid water to solid ice has occurred, when compared to foodstuffs processed by tunnel freezers or methods known from the art.

The present disclosure further provides for a tunnel freezer, a method for operating the same, and a method for freezing foodstuffs wherein a distribution of the final average temperatures of batches of foodstuffs frozen using the tunnel freezer or either method, has a smaller variance than a distribution of the final average temperatures of batches of foodstuffs frozen using a tunnel freezer or method known from the art.

At least some of the abovementioned objects are at least partially addressed in a tunnel freezer according to the first independent claim herein, which is configured to freeze foodstuffs that are arranged in a layer. The tunnel freezer comprises a housing and a conveyor unit. The housing comprises a plurality of housing sections. The conveyor unit is configured to convey the layer of foodstuffs through each of the plurality of housing sections. Each housing section comprises a ventilator, for providing a stream of a gaseous medium, and a cooling unit arranged to cool the gaseous medium in the stream. A first housing section from the plurality of housing sections is configured to force the stream of gaseous medium to flow through the layer of foodstuffs in a first direction. A second housing section from the plurality of housing sections is configured to force the stream of gaseous medium to flow through the layer of foodstuffs in a second direction, different from the first direction.

It is advantageous to trigger the aforementioned freezing of the foodstuffs and/or corresponding jumps in temperature when a substantial part of the foodstuffs is receptive thereto. In a preferred embodiment, the conveyor unit is configured to convey the layer of foodstuffs from the first section into the second section when a percentage of the foodstuffs that is in a supercooled state is within a predetermined range, the range preferably being from 20% to 80%, more preferably from 30% to 70%, and even more preferably from 40% to 60%.

The effect of embodiments of the disclosure is maximized when the first and second direction are opposite to each other. In existing tunnel freezers, the first direction is generally from the bottom up, in which case the most advantageous second direction is from the top down.

In some embodiments, which are relatively simple to implement and thus advantageous, the housing is elongated and the plurality of housing sections is longitudinally distributed over the elongated housing.

Preferably, the gaseous medium is air.

At the same time, the more the first and second directions differ from one another, the more they may collide with one another. To limit this, in some embodiments, the first and second housing sections are substantially isolated from one another such that the streams of gaseous medium flowing through these respective housing sections are substantially contained in the respective housing section.

In some embodiments, the plurality of housing sections further comprises a third housing section configured to force the stream of gaseous medium to flow through the layer of foodstuffs in the first direction, and the conveyor unit is configured to convey the foodstuffs through the first, the second, and the third housing section, in that order. Such a configuration results in two changes in direction thereby achieving the advantageous technical effect twice.

In a preferred embodiment, the amount of time for which the foodstuffs are conveyed through the first housing section is approximately twice the amount of time for which the foodstuffs are conveyed through the second housing section and/or the third housing section, and/or wherein the amounts of time for which the foodstuffs are conveyed through the second and third housing sections are approximately equal. In a preferred embodiment, the conveyor unit is configured to convey the foodstuffs through the first, second, and third housing sections at a substantially constant speed.

To enable a continuous process of freezing individual foodstuffs, the conveyor unit may be a belt conveyor comprising a conveyor belt over which the foodstuffs can be spread out to form the layer. The conveyor belt is preferably provided with a plurality of holes for allowing the stream of gaseous medium to flow through the conveyor belt.

To avoid, in housing sections configured to force the stream of gaseous medium to flow through the layer of foodstuffs from the top down, the stream of gaseous medium from pressing the layer together, the belt may be suspended with slack. This slack results in the layer rearranging itself while being conveyed, thus creating new places through which air can pass through.

In some embodiments, the first housing section is configured to force the stream of gaseous medium to flow through the conveyor unit from the bottom up, and/or the second housing section is configured to force the stream of gaseous medium to flow through the conveyor unit from the top down.

The stream of gas may be provided in a number of ways. In some embodiments, each housing section is divided into a first partition and a second partition, wherein the second partition is delimited from the first partition by the conveyor unit and by partitioning means that comprise an opening in which the ventilator is arranged. The conveyor unit can be permeable to the gaseous medium, and the partitioning means can be made of a material that is not permeable to the gaseous medium.

Specifically, in some embodiments, at least a part of the first partition is adjacent to a lower side of the conveyor unit and/or at least a part of the second partition is adjacent to an upper side of the conveyor unit.

In some embodiments, the gaseous medium is forced from the first partition, through the conveyor unit and, when arranged thereupon, through the layer of foodstuffs, into the second partition, thereby providing the stream of gaseous medium, by, in the first housing section, arranging the ventilator to draw gaseous medium from the second partition, and to push it into the first partition, and/or to increase the pressure in the first partition with respect to the second partition.

Similarly, in some embodiments, the gaseous medium is forced from the second partition, through the conveyor unit and, when arranged thereupon, the layer of foodstuffs, into the first partition, thereby providing the stream of gaseous medium, by, in the second housing section, arranging the ventilator to draw gaseous medium from the first partition, and to push it into the second partition, and/or to decrease the pressure in the first partition with respect to the second partition, thereby forcing gaseous medium from the second partition.

In some embodiments, the first and second housing sections are adjacent to one another.

In some embodiments, a housing wall is arranged in between the first housing section and the second housing section, the housing wall comprising a slot through which the conveyor unit extends. For those embodiments, the conveyor unit may comprise a first side on which the layer of foodstuffs is to be transported and an opposing second side. In such embodiments, the tunnel freezer may further comprise slats that are hingedly attached to a first edge of the slot opposite to the first side of the conveyor unit, and/or that are configured to contain the streams of gaseous material at least partially in housing sections on either side of the housing wall.

Specifically, a clearance between the second side of the conveyor unit and a second edge of the slot opposite to the second side is preferably sufficiently small to allow a pressure difference to exist between the first partition of the first housing section and the first partition of the second housing section.

The slot may extend at least partially into a part of the housing wall arranged in between the second partition of the first housing section and the second partition of the second housing section, and/or the slot may not extend into a part of the housing wall arranged in between the first partition of the first housing section and the first partition of the second housing section.

Similarly, the plurality of housing sections may comprise an end housing section, being either a front housing section or a rear housing section, and a part of the housing that delimits the end housing section comprises an opening through which the conveyor unit extends. This opening may extend at least partially into a part of the housing delimiting the second partition of the end housing section, and/or may not extend into a part of the housing delimiting the first partition of the end housing section.

To further limit the leakage of air from the housing sections to an outside, the pressure in the first partitions of each of the housing sections can be substantially equal to an ambient pressure and/or is substantially equal to a standard atmospheric pressure.

Some of the foodstuffs for which embodiments of the disclosure are advantageous are fries, green beans, carrots, or any other type of elongated foodstuffs.

The skilled person will appreciate that, depending on the actual freezer in question, temperatures in use will vary. In some implementations, in the first and second housing sections, the gaseous medium flowing through the layer of foodstuffs is between about −18 degrees Celsius to about −36 degrees Celsius, preferably about −24 degrees Celsius. In some implementations, the plurality of housing sections further comprises a pre-cooling section in which gaseous medium flowing through the layer of foodstuffs is between about 28 degrees Celsius and about −1 degrees Celsius, wherein the conveyor unit is preferably configured to first convey the foodstuffs into the pre-cooling section.

According to a further aspect of the disclosure, provided is a method for freezing foodstuffs that are arranged in a layer, preferably using a tunnel freezer according to any of the embodiments described above. The method comprises:
conveying, using a conveyor unit, the layer of foodstuffs through each of the plurality of housing sections comprised in a housing,
in each housing section, providing a stream of a gaseous medium and cooling the gaseous medium in the stream,
forcing, in a first housing section from the plurality of housing sections, the stream of gaseous medium to flow through the layer of foodstuffs in a first direction, and
forcing, in a second housing section from the plurality of housing sections, the stream of gaseous medium to flow through the layer of foodstuffs in a second direction, different from the first direction.

According to a further aspect of the disclosure, provided is a method for operating a tunnel freezer for freezing foodstuffs. Such a tunnel freezer comprises a housing and a conveyor unit. The housing comprises a plurality of housing sections. The conveyor unit is configured to convey the layer of foodstuffs through each of the plurality of housing sections. Each housing section comprises a ventilator, for providing a stream of a gaseous medium, and a cooling unit arranged to cool the gaseous medium in the stream. A first housing section from the plurality of housing sections is configured to force the stream of gaseous medium to flow through the layer of foodstuffs in a first direction. A second housing section from the plurality of housing sections is configured to force the stream of gaseous medium to flow through the layer of foodstuffs in a second direction, different from the first direction. The method comprises:
determining, for the foodstuffs, a supercooled temperature range in which water in the foodstuff is supercooled;
cooling, in the first housing section, the layer of foodstuff until an average temperature of the foodstuff is in the supercooled temperature range; and
conveying, when the average temperature of the foodstuff is in the supercooled temperature range, the layer of foodstuffs into the second housing section.

Preferably, this method is implemented in an embodiment of a tunnel freezer as described in this disclosure.

### BRIEF DESCRIPTION OF THE DRAWINGS

Embodiments of the present disclosure will be described referring to the appended drawings, wherein identical or similar components are referred to using identical reference signs, and wherein:

FIG. 1 shows a cross-section of a tunnel freezer according to embodiments of the disclosure;

FIGS. 2A and 2B show isometric perspective views of the freezing sections of the tunnel freezer of FIG. 1;

FIGS. 3A and 3B show cross-sections of a conventional freezing section;

FIGS. 4A and 4B show cross-sections of a freezing section in which the flow of air is reversed; and

FIG. 5 shows temperature over time for some individual parts in the process of being frozen.

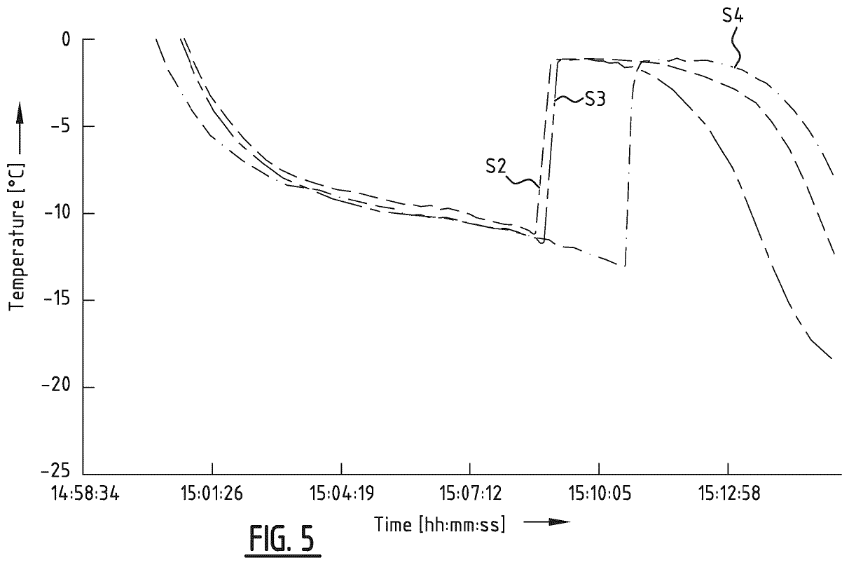

### DETAILED DESCRIPTION

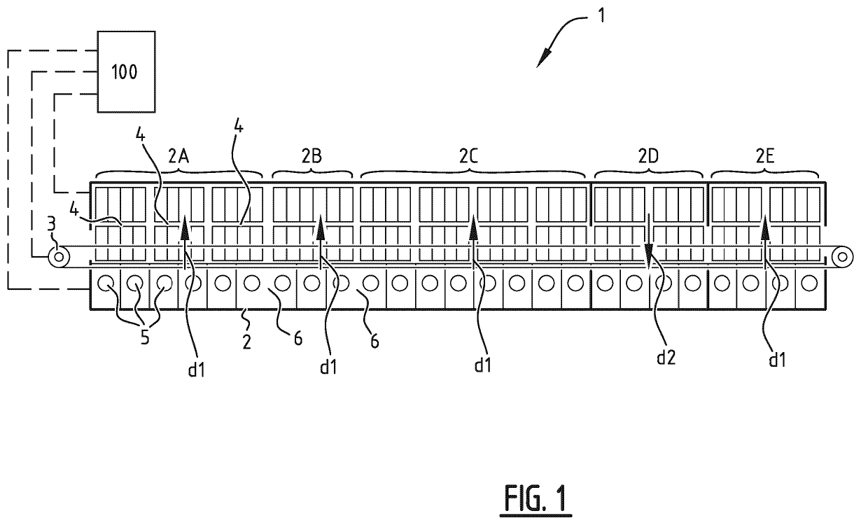

Referring to FIG. 1, a cross-section of a tunnel freezer 1 is shown. The tunnel freezer 1 comprises an elongated housing 2, a belt conveyor 3, a plurality of cooling elements 4, and a plurality of ventilators 5. The elongated housing 2 is divided into housing sections 2A, 2B, 2C, 2D, and 2E. The tunnel freezer 1 may further comprise a controller 100 that is functionally connected to at least the belt conveyor 3, the plurality of cooling elements 4, and the plurality of ventilators 5.

The elongated housing 2 is divided into a precool section 2A, a water cool section 2B, and three freezing sections 2C, 2D, and 2E. Each section comprises a number of cooling elements 4 and a number of ventilators 5 from the corresponding pluralities thereof. The skilled person will appreciate that the housing sections 2A, 2B, 2C, 2D, and 2E may be provided with any number of cooling elements 4 and/or ventilators 5.

In the tunnel freezer 1, the precool section 2A and the water cool section 2B may be provided with cooling elements 4 that rely on water as a coolant. Freezing sections 2C, 2D, and 2E may be provided with cooling elements 4 that rely on ammonia as coolants. However, the skilled person will appreciate that use of other heat transfer liquids is also possible and that other cooling elements in general may also be used.

The foodstuffs can be arranged on the belt conveyor 3 in the form of a layer, and, in that form, conveyed through the elongated housing 2. Considering the tunnel freezer 1 from the point of view in FIG. 1, the foodstuffs are conveyed from left to right, passing through each of the housing sections 2A, 2B, 2C, 2D, and 2E. The skilled person will be aware that the belt conveyor 3 is just one implementation of a conveyor unit and that other conveyor units may be used as well, such as roller conveyors, tray conveyors, etc.

To cool and eventually freeze the foodstuffs, the tunnel freezer 1 is configured to force a stream of cold air through the layer of foodstuffs. The ventilators 5 are configured for providing the stream of air, and the cooling elements 4 are for cooling the air in the stream of air. Embodiments are conceivable in which a gaseous medium other than air is relied upon. The tunnel freezer 1 may specifically be an “individual quick-frozen,” or IQF tunnel.

In the context of the present disclosure, the term ventilators (as used to describe elements 5, 5A, and/or 5B) should be understood as encompassing regular ventilators, but the term should not be understood as being limited thereto. Means provided with turbine wheels or other turbine-like implementations, also suitable for providing the required flow of air, are also encompassed thereby.

In the precool sections 2A and 2B, the air flowing through the layer of foodstuffs is between about 28 degrees Celsius to about −1 degree Celsius. In each of the freezing sections 2C, 2D, and 2E, the air flowing through the layer of foodstuffs is between about −18 degrees Celsius to about −36 degrees Celsius, preferably about −24 degrees Celsius.

Precool section 2A, water cool section 2B, and freezing sections 2C and 2E are each configured to force the stream of air through the layer of foodstuff from the bottom up, indicated in FIG. 1 as first direction d1. Freezing section 2D is configured to force the stream through the layer of foodstuffs from the top down, indicated in FIG. 1 as second direction d2.

The applicant finds that freezing a layer of foodstuffs by forcing air through the layer in merely a single direction results in a non-uniformly frozen layer. In tunnel freezer 1, for example, this would happen if the layer of foodstuffs would be conveyed through just housing sections 2A, 2B, and 2C.

In the context of this disclosure, non-uniformly frozen should be understood as meaning and including that either (a) in foodstuffs at a first side of the layer, the desired phase change from liquid water to solid ice has occurred more often than at a second, opposite side of the layer, and/or (b) foodstuffs at the second, opposite side of the layer are more often in a supercooled state than foodstuffs at the first side of the layer. Non-uniformly frozen should not be understood as meaning or including that the foodstuffs at the first side of the layer are necessarily colder than at the second, opposite side.

The applicant finds that changing the direction from which air is forced through the layer triggers the desired phase change from liquid water to solid ice in a lot of, if not all of, the foodstuffs that are in a supercooled state. In the tunnel freezer 1, for example, this happens when the layer of foodstuffs is conveyed from freezing section 2C into freezing section 2D and again when the layer of foodstuffs is conveyed from freezing section 2D into freezing section 2E. These changes in direction alleviate the aforementioned problem at least somewhat and help to provide a more uniformly frozen layer.

Any change in direction achieves the abovementioned affect. The applicant finds, however, that the larger the change, the larger the effect. Therefore, it is not necessary that the directions d1 and d2 in the tunnel freezer 1 are opposite each other, but it is particularly effective.

Embodiments are also conceivable in which the difference between the first direction d1 and the second direction d2 is at least 10 degrees, at least 45 degrees, or at least 90 degrees, when considered in the convey direction.

Furthermore, while in the tunnel freezer 1, the flow of air is changed at two points along conveyer unit (e.g., belt conveyor 3) (from section 2C to 2D, and from section 2D to 2E), only one change in direction will also already provide the desired effect.

Triggering these phase changes in the tunnel freezer 1 ensures that the latent heat is released in an environment generally capable of removing this heat from the foodstuffs.

Triggering these phase changes in the tunnel freezer 1 also ensures that they do not eventually happen when the foodstuffs are in storage. Foodstuffs cooled using a tunnel freezer according to embodiments of the disclosure will therefore have a more constant final average temperature.

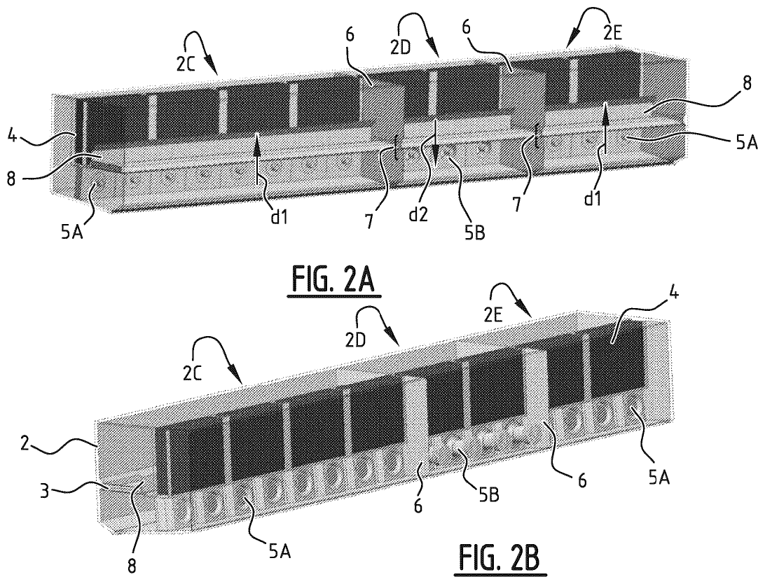

Referring to FIGS. 2A and 2B, the freezing sections 2C, 2D, and 2E are shown. Each freezing section comprises cooling elements 4. In FIGS. 2A and 2B specifically, it is shown that, in freezing sections 2C and 2E, first ventilators 5A are arranged to force air through the layer of foodstuffs upwards (first direction d1), and that, in section 2D, second ventilators 5B are arranged to force air through the layer from the top down (second direction d2). In both FIGS. 2A and 2B, the foodstuffs are conveyed that can generally be described as from left to right.

Between freezing section 2C and freezing section 2D, and between freezing section 2D and freezing section 2E, housing walls 6 are provided. In these housing walls 6, slots 7 are provided through which the conveyor unit (e.g., belt conveyor 3) extends. The tunnel freezer 1 as shown in FIGS. 2A and 2B is also provided with optional deflector plates 8. Optionally, the housing walls 6 are also provided in between housing sections 2A and 2B and in between housing sections 2B and 2C.

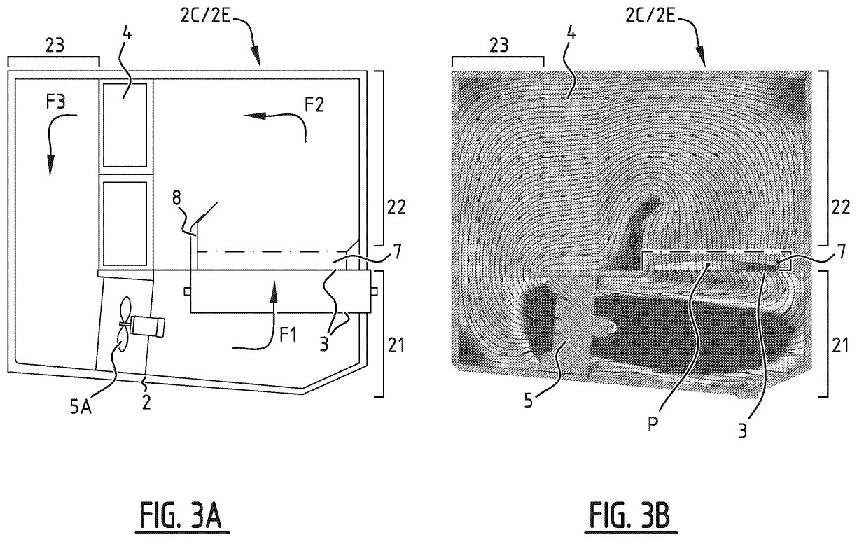

Referring to FIGS. 3A and 3B, a cross-section in a plane perpendicular to the convey direction that represents either freezing section 2C or 2E is shown. Freezing section 2C/2E again comprises the housing 2, the belt conveyor 3, one or more cooling elements 4, one or more ventilators 5A, the slot 7, and the deflector plates 8.

In FIG. 3A, it is specifically indicated that the housing 2 is divided into a first partition 21, a second partition 22, and a third partition 23. Air flows, from ventilator 5A, through the first partition 21 (in a direction of arrow F1), to the belt conveyor 3. Air flows further through the belt conveyor 3, and, when present thereon, is forced through the layer of foodstuffs. Air flows further from the belt conveyor 3, through the second partition 22 (in a direction of arrow F2), to the cooling element 4. Air flows further through the cooling element 4, being cooled in the process. Air flows further from the cooling element 4, through the third partition 23 (in a direction of arrow F3), back to the ventilator 5A.

In FIG. 3B, the darker areas indicate higher air velocities. By pushing air into the first partition 21, the ventilator 5A increases the pressure in the first partition 21. Meanwhile, the pressure in the second partition 22 generally stays the same or slightly increases. The resulting difference in pressure naturally ensures that the air present in the first partition 21 forces its way through the belt conveyor 3, and, when present, the layer of foodstuffs P, from the bottom up, into the second partition 22.

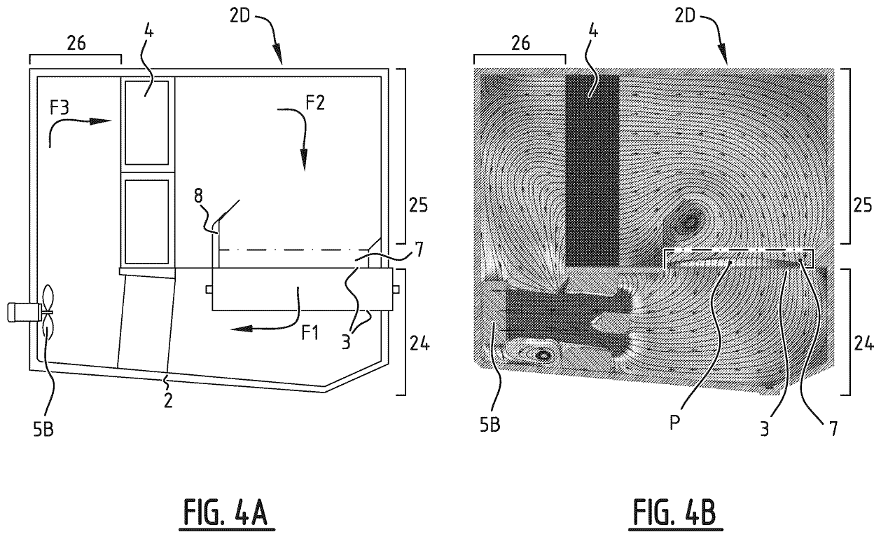

Referring to FIGS. 4A and 4B, a cross-section in a plane perpendicular to the convey direction of the freezing section 2D is shown. The freezing section 2D again comprises the housing 2, the belt conveyor 3, one or more cooling elements 4, one or more ventilators 5A, the slot 7, and the deflector plates 8.

In FIG. 4A, it is specifically indicated that the housing 2 is divided into a fourth partition 24, a fifth partition 25, and a sixth partition 26. Air flows through the sixth partition 26 (in a direction of arrow F3), to the cooling element 4. Air flows further through the cooling element 4, being cooled in the process. Air flows further from the cooling element 4, through the fifth partition 25 (in a direction of arrow F2), to the belt conveyor 3. Air flows further through the belt conveyor 3, and, when present thereon, is forced through the layer of foodstuffs P (FIG. 4B). Air flows further, from the belt conveyor 3, through the fourth partition 24 (in a direction of arrow F1), toward the ventilator 5B. In FIG. 4B, the darker areas indicate higher air velocities. By pulling air from the fourth partition 24, the ventilator 5B decreases the pressure in the fourth partition 24. Meanwhile, the pressure in the fifth partition 25 generally stays the same or slightly increases. The resulting difference in pressure naturally ensures that the air present in the fifth partition 25 forces its way through the belt conveyor 3 and, when present, the layer of foodstuffs P, from the top down, into the fourth partition 24.

Embodiments of freezing section 2C/2E (FIGS. 3A and 3B) are conceivable in which the upward stream of air is enacted by decreasing the pressure in the second partition 22, while generally keeping the pressure in the first partition 21 the same. Embodiments of freezing section 2D (FIGS. 4A and 4B) are conceivable in which the downward stream of air is enacted by increasing the pressure in the fifth partition 25, while generally keeping the pressure in the fourth partition 24 the same. In both types of freezing sections, what causes the stream of air to flow is the difference in pressures between the two partitions below and above belt conveyor 3, respectively.

To ensure that the belt conveyor 3 can convey the layer of foodstuffs from freezing section 2C into freezing section 2D, and from freezing section 2D into freezing section 2E, the slots 7 are provided in the housing walls 6.

The slots 7 are large enough for the belt conveyor 3 to extend through, and to extend into, the parts of the housing walls 6 that delimit the second partition 22 of freezing sections 2C/2E from the fifth partition 25 of freezing section 2D.

Preferably, the slots 7 extend into the part of the housing walls 6, with a distance approximately equal to the thickness of the layer of foodstuffs, or a little farther. This allows for the layer of foodstuffs to pass through the slot 7. The slots 7 result in an open connection between the second partition 22 of freezing sections 2C/2E and the fifth partition 25 of freezing section 2D, for the foodstuffs to pass through.

The skilled person will therefore appreciate that the tunnel freezer 1 is a particularly advantageous embodiment, as therein, in each housing section, the required difference in pressure between the partition above and the partition below the belt conveyor 3 is provided by changing (e.g., increasing/decreasing) the pressure in the partition below the belt conveyor 3 (e.g., in the first partition 21, in the fourth partition 24), while generally keeping the pressure in the partition above belt conveyor 3 (e.g., in the second partition 22, in the fifth partition 25) the same.

Optionally, slats may be hingedly attached to or on an upper edge of the slot 7. This is the edge of the slot 7 opposite the side of the belt conveyor 3 on which the foodstuffs may be arranged. Such slats have a resting position in which gravity pulls the slats downwards, providing substantial blockage between the adjoining housing sections delimited by the corresponding housing wall 6. As the slats are hingedly attached, passing foodstuffs can push the slats aside to ensure passing. These slats improve containment of the streams of air material in the adjoining housing sections delimited by the corresponding housing wall 6.

Preferably, the slots 7 do not extend into the part of the housing walls 6 that delimited the first partition 21 (FIGS. 3A and 3B) of freezing sections 2C/2E from the fourth partition 24 of section 2D. This allows for sealing off the first partition 21 of section 2C or 2E from the fourth partition 24 of section 2D and vice-versa. This seal maybe achieved by the lower edge of the slots 7 being as close to a lower side of the belt conveyor 3 as possible. Alternatively, it may be achieved by providing, between the lower edge of the slots 7 and the lower side of the belt conveyor 3, some additional sealing means, such as one or more rubber elements.

Such a seal, in combination with the earlier discussed arrangement of the ventilators 5A and 5B, enables higher pressure differences between the first partition 21 of section 2C or 2E and the fourth partition 24 of section 2D and vice-versa.

To avoid blockage in the layer of foodstuffs when the stream of air is forced through the layer from the top down, the conveyor belt included in the belt conveyor 3 may be suspended with slack. In the context of this disclosure, this should be understood as meaning and including that, between pullies suspending the conveyor belt, the conveyor belt, starting from one pully, first decreases in height and then increases in height, before arriving at the next pully. This slack creates variations in the slope of the conveyor belt. When being conveyed over a conveyor belt that includes a change in slope, specifically when the slope changes downward, and even specifically when the slope changes from a positive slope to a negative slope, the layer of foodstuffs has a natural tendency to rearrange itself at least somewhat, creating new openings in the layer of foodstuffs for the stream of air to be forced through, from the top down. Other means for rearranging the layer of foodstuff may be included as well.

The skilled person will appreciate that the tunnel freezer 1 may be operated for freezing any one of various types of foodstuffs. Given a particular type of foodstuffs, a supercooled temperature range maybe determined. The supercooled temperature range includes those temperatures of the foodstuffs at which water present in the foodstuffs is supercooled.

The layer of foodstuffs may then be cooled until an average temperature of the foodstuffs is in the supercooled temperature range. For the tunnel freezer 1, this may, for example, be achieved using freezing section 2C or the combination of housing sections 2A, 2B, and 2C. To achieve this, a number of configuration of the tunnel freezer 1 may be adapted, such as, but not limited to, the speed of the belt conveyor 3, the cooling capacity of the cooling elements 4, and/or the power provided to the plurality of ventilators 5.

The layer of foodstuffs may then be conveyed, when the average temperature of the foodstuffs is in the supercooled temperature range, into the second housing section. For the tunnel freezer 1, this may be achieved by the belt conveyor 3 conveying the layer of foodstuffs from freezing section 2C into freezing section 2D.

In the above disclosure, detailed embodiments have been described. However, the present invention is not limited to these embodiments. Instead, various modifications are possible without deviating from the scope of the present invention, which is defined by the appended claims.

1. A tunnel freezer configured to freeze foodstuffs that are arranged in a layer, the tunnel freezer comprising:
a housing comprising a plurality of housing sections;
a conveyor unit configured to convey the layer of foodstuffs through each of the plurality of housing sections; and
each housing section, of the plurality of housing sections, comprising:
a ventilator for providing a stream of a gaseous medium; and
a cooling unit arranged to cool the gaseous medium in the stream;
wherein:
a first housing section, of the plurality of housing sections, is configured to force the stream of the gaseous medium to flow in a first direction through the layer of foodstuffs;
a second housing section, of the plurality of housing sections, is configured to force the stream of the gaseous medium to flow in a second direction through the layer of foodstuffs, the second direction being different from the first direction;
the foodstuffs have a determined supercooled temperature range in which water in the foodstuffs is supercooled;
the first housing section is configured to cool the layer of foodstuffs until an average temperature of the foodstuffs is in the supercooled temperature range; and
the conveyor unit is configured to convey, when the average temperature of the foodstuffs is in the supercooled temperature range, the layer of foodstuffs into the second housing section.

2. (canceled)

3. The tunnel freezer of claim 1, wherein the conveyor unit is configured to convey the layer of foodstuffs from the first housing section into the second housing section when a percentage of the foodstuffs that is in a supercooled state is within a predetermined range, the predetermined range being from 20% to 80%, from 30% to 70%, or from 40% to 60%.

4. The tunnel freezer of claim 1, wherein:
the first direction is either from the top down, or from the bottom up, and/or
the second direction is opposite to the first direction.

5. The tunnel freezer of claim 1, wherein:
the housing is elongated; and
the plurality of housing sections is longitudinally distributed over the elongated housing.

6. (canceled)

7. The tunnel freezer of claim 1, wherein the first housing section and the second housing section are substantially isolated from one another such that the streams of the gaseous medium flowing through these respective housing sections are substantially contained in the respective housing section.

8. The tunnel freezer of claim 1, wherein:
the plurality of housing sections further comprises a third housing section configured to force the stream of the gaseous medium to flow in the first direction through the layer of foodstuffs; and
the conveyor unit is configured to convey the layer of foodstuffs through the first housing section, the second housing section, and the third housing section, in that order.

9. The tunnel freezer of claim 8, wherein the conveyor unit is configured such that:
an amount of time for which the layer of foodstuffs is conveyed through the first housing section is approximately twice an amount of time for which the layer of foodstuffs is conveyed through the second housing section and/or approximately twice an amount of time for which the layer of foodstuffs is conveyed through the third housing section, and/or
the amount of time for which the layer of foodstuffs is conveyed through the second housing section is approximately equal to the amount of time for which the layer of foodstuffs is conveyed through the third housing section.

10. The tunnel freezer of claim 8, wherein the conveyor unit is configured to convey the layer of foodstuffs through the first housing section, the second housing section, and the third housing section at a substantially constant speed.

11. The tunnel freezer of claim 1, wherein the conveyor unit is a belt conveyor comprising:
a conveyor belt over which the foodstuffs can be spread out to form the layer, the conveyor belt being configured to allow the stream of the gaseous medium to flow through the conveyor belt.

12. The tunnel freezer of claim 11, wherein, in at least one of the housing sections configured to force the stream of the gaseous medium to flow through the layer of foodstuffs from the top down, the conveyor belt is suspended with slack.

13. (canceled)

14. The tunnel freezer of claim 1, wherein:
each housing section, of the housing sections configured to force the stream of the gaseous medium to flow through the layer of foodstuffs, is divided into a first partition and a second partition, the second partition being delimited from the first partition by the conveyor unit and by partitioning means that comprise an opening in which the ventilator is arranged;
the conveyor unit is permeable to the gaseous medium; and
the partitioning means are not permeable to the gaseous medium.

15. The tunnel freezer of claim 14, wherein:
at least a part of the first partition is adjacent to a lower side of the conveyor unit; and/or
at least a part of the second partition is adjacent to an upper side of the conveyor unit.

16. The tunnel freezer of claim 14, wherein, in the first housing section, the ventilator is arranged to draw the gaseous medium from the second partition, and to push the gaseous medium into the first partition, and/or to increase a pressure in the first partition with respect to the second partition, thereby forcing the gaseous medium from the first partition, through the conveyor unit and, when arranged upon the conveyor unit, through the layer of foodstuffs, into the second partition, thereby providing the stream of the gaseous medium.

17. The tunnel freezer of claim 14, wherein, in the second housing section, the ventilator is arranged to draw the gaseous medium from the first partition, and to push the gaseous medium into the second partition, and/or to decrease a pressure in the first partition with respect to the second partition, thereby forcing the gaseous medium from the second partition, through the conveyor unit and, when arranged upon the conveyor unit, through the layer of foodstuffs, into the first partition, thereby providing the stream of the gaseous medium.

18. (canceled)

19. The tunnel freezer of claim 14, further comprising:
a housing wall arranged in between the first housing section and the second housing section, the housing wall defining a slot through which the conveyor unit extends.

20. The tunnel freezer of claim 19, wherein:
the conveyor unit comprises:
a first side on which the layer of foodstuffs is to be transported; and
a second side opposing the first side; and
wherein a clearance between the second side of the conveyor unit and a second edge of the slot opposite to the second side is sufficiently small to allow a pressure difference to exist between the first partition of the first housing section and the first partition of the second housing section.

21-22. (canceled)

23. The tunnel freezer of claim 14, wherein the slot:
does extend at least partially into a part of the housing wall arranged in between the second partition of the first housing section and the second partition of the second housing section, and/or
does not extend into a part of the housing wall arranged in between the first partition of the first housing section and the first partition of the second housing section.

24. The tunnel freezer of claim 14, wherein the plurality of housing sections comprises an end housing section, the end housing being either a front housing section or a rear housing section, a part of the housing that delimits the end housing section defining an opening through which the conveyor unit extends, and wherein the opening:
does extend at least partially into a part of the housing delimiting the second partition of the end housing section, and/or
does not extend into a part of the housing delimiting the first partition of the end housing section.

25. The tunnel freezer of claim 23, wherein a pressure in the first partition of each of the housing sections is substantially equal to an ambient pressure and/or is substantially equal to a standard atmospheric pressure.

26. The tunnel freezer of claim 1, wherein:
in the first housing section and in the second housing section, the gaseous medium flowing through the layer of foodstuffs is at a temperature between about −18 degrees Celsius to about −36 degrees Celsius;
the plurality of housing sections further comprises a pre-cooling section in which the gaseous medium flowing through the layer of foodstuffs is at a temperature between about 28 degrees Celsius and about −1 degrees Celsius; and
the conveyor unit is configured to convey the layer of foodstuffs into the pre-cooling section before conveying the layer of foodstuffs into the first housing section and the second housing section.

27. (canceled)

28. A method for freezing foodstuffs that are arranged in a layer, the foodstuffs having a determined supercooled temperature range in which water in the foodstuffs is supercooled, the method comprising:
conveying, using a conveyor unit, the layer of the foodstuffs through each of a plurality of housing sections comprised in a housing;
in each housing section, of the plurality of housing sections, providing a stream of a gaseous medium and cooling the gaseous medium in the stream;
forcing, in a first housing section of the plurality of housing sections, the stream of the gaseous medium to flow in a first direction through the layer of the foodstuffs, and cooling, in the first housing section, the layer of the foodstuffs until an average temperature of the foodstuffs is in the supercooled temperature range;
conveying, using the conveyor unit and when the average temperature of the foodstuffs is in the supercooled temperature range, the layer of the foodstuffs into a second housing section of the plurality of housing sections; and
forcing, in the second housing section, the stream of the gaseous medium to flow in a second direction through the layer of the foodstuffs, the second direction being different from the first direction.

29. A method for operating a tunnel freezer for freezing foodstuffs, the foodstuffs having a determined supercooled temperature range in which water in the foodstuffs is supercooled, the tunnel freezer comprising:
a housing, comprising a plurality of housing sections;
a conveyor unit configured to convey a layer of the foodstuffs through each housing section of the plurality of housing sections;
each housing section, of the plurality of housing sections, comprising:
a ventilator for providing a stream of a gaseous medium; and
a cooling unit arranged to cool the gaseous medium in the stream;
wherein:
a first housing section, of the plurality of housing sections, is configured to force the stream of the gaseous medium to flow in a first direction through the layer of the foodstuffs,
a second housing section, of the plurality of housing sections, is configured to force the stream of the gaseous medium to flow in a second direction through the layer of the foodstuffs, the second direction being different from the first direction;
the method comprising:
cooling, in the first housing section, the layer of the foodstuffs until an average temperature of the foodstuffs is in the supercooled temperature range; and
conveying, when the average temperature of the foodstuffs is in the supercooled temperature range, the layer of the foodstuffs into the second housing section.

30. (canceled)
